(19) United States
(12) Patent Application Publication
(10) Pub. No.: US 2006/0274642 A1
(43) Pub. Date: Dec. 7, 2006

(54) Fail open high availability

(75) Inventors: Moshe Litvin, Tal Shahar (IL); Gil Harari, Hod Hasharon (IL); Alon Kantor, Tel Aviv (IL)

Correspondence Address: DR. MARK FRIEDMAN LTD.;C/o Bill Polkinghorn, 9003 Florin Way, Upper Marlboro, MD, 20772, US

(73) Assignee: Check Point Software Technologies Ltd.

(21) Appl. No.: 11/140,913

(22) Filed: Jun. 1, 2005

(51) Int. Cl. H04L 12/26

(52) U.S. Cl. 370/216

(57) ABSTRACT

A system and method for providing high availability for data communications between two data networks. The system comprises at least two network modules for operatively connecting two data networks. Each network module includes a first and a second network interfaces. The network modules are interconnected using the first network interfaces. The data networks are connected respectively to the second network interfaces. A security or service module is included between the first and second network interfaces in each network module to provide security or otherwise a network service. Upon failure of one of the network modules, its two network interfaces are interconnected, thereby maintaining data traffic between the two network interfaces and between the two data networks.

### FIELD AND BACKGROUND OF THE INVENTION

The present invention relates to a system for maintaining high availability in computer networks and, more particularly for providing high availability for security modules in a data network, without a special configuration of the network components of the data network.

Society has become dependent on the availability of computer networks. If a network goes down, or is otherwise unavailable, the cost to an organization is enormous. Consequently, a number of techniques have arisen to ensure that a computer network is designed to respond to failures of its components. Such a network maintains “high availability”. One method, known as “failover”, is used to insure high availability by automatically switching to a redundant or standby network component upon the detection of a failure or abnormal termination of a currently active network component. Failover typically happens without human intervention. Prior art failover mechanisms are disclosed for instance in U.S. Pat. No. 6,763,479.

High availability has additional significance for a network component that includes a security function such as a firewall which inspects data traffic. Firewalls use a set of rules to compare incoming data packets to specific known attacks. A firewall accepts and denies traffic between network domains. In many cases there are three or more domains where the first domain is an internal network such as in a corporate organization. Outside the internal network is a second network domain where both the internal network and the outside world have access, sometimes known as a “demilitarized zone” or DMZ. The third domain is the external network of the outside world. Servers accessible to the outside world are put in the DMZ. In the event that a server in the DMZ is compromised, the internal network is still safe.

If a network component fails, such as a gateway between two networks, traffic between the two networks is typically stopped. If the gateway includes a module, such as a firewall, which provides security to the network, the network manager needs to make a choice, either to bypass the firewall, connecting the internal network without the firewall and risk a security breach or wait until the firewall is repaired or replaced. In order to avoid this situation, the network manager may install a high availability solution such as “failover” to a second (redundant) network component upon detection of failure in the first (active) network component. Failover, as a high availability solution, requires a special configuration for all the network components in use and requires considerable expertise and time until the high availability solution is operational and qualified.

There is thus a need for, and it would be highly advantageous to have a system for providing high availability in a network without requiring a special configuration for the network components.

### SUMMARY OF THE INVENTION

The term “open” as used herein refers to a state of security, for instance an “open” door which allows traffic. The term “closed” as used herein likewise refers to a state of security which stops data traffic. The term “fail-open” refers to a network component which passes data traffic during failure of at least a portion of the network component. The term “fail-close” refers to a programmed or hardware configuration typically of a network component that stops the flow of data traffic through the network component upon failure of the network component. The term “chain” refers to connecting together two or more network devices in a repetitive fashion. The terms “security engine” and “security module” are used herein interchangeably and refer to any module which provides security to either data traffic and/or to a data network using any of the methods known in the art. The term “network interface” refers to functionality beyond the physical layer. The term “network connection” refers only to the physical layer.

According to the present invention there is provided a method for providing high availability for data communications between two data networks. The method uses two network modules for connecting the two data networks. Each of the network modules include two network interfaces. The two network modules are connected together using the first network interfaces of the two network modules. The two data networks are connected to the second network interfaces of the two network modules. A service of the same type is provided by each of the network modules. Upon failure of each of the network modules, the two interfaces of the failed module are connected thereby maintaining data traffic between the two network interfaces. The service provided may be data inspection, data encryption, data filtering, data compression, and/or quality of service differentiation when the two network modules are preferably internally synchronized,and the service is continued by the second network module upon failure of the first network module. Preferably, the failure is detected and the interconnecting is performed using an external network management system operatively connected to each network module.

According to the present invention there is provided a network device connecting pairwise two or more data networks. The device includes two or more network modules. Each network module includes two interfaces and a mechanism which upon failure of the network module, interconnects the two interfaces, thereby maintaining data traffic between the two interfaces. The network modules are connected in series using the two interfaces, thereby producing one or more chains of the network modules. Each chain is further connected to the two data networks using the interfaces terminal to the chain. Each network module further includes a service module, e.g. firewall, inspection, filter, encryption, compression, quality of service, which provides a service to the data traffic and/or data network. Preferably, the mechanism is further based on a signal received from another of the network modules, wherein the signal validates proper function of the another network module. Preferably, the mechanism uses an external network management system. The data traffic does not pass when all the network modules fail. Preferably, the service is performed by the chain when at least one of the network modules of the chain is functional. Preferably, the network module further includes a load balancing module which transfers a portion of the data traffic to at least one other of the network modules.

According to the present invention there is provided, a cluster which includes multiple gateway devices. The cluster is connected to multiple data networks. The gateway device includes multiple fail-open interface modules. The fail-open interface modules each include a first network interface; a second network connection; and a mechanism which upon failure of at least a portion of the at least one gateway device, operatively connects the first network interface to the second network connection, thereby maintaining data traffic between the first network interface and the second network connection. The first network interface is connected to one of the data networks and the second network connection of each gateway device is connected pairwise selectably to either: the first network interface of one of the fail-open modules of the subsequent gateway device of the chain, or a regular network interface when the subsequent gateway device is the last gateway device of the chain. Preferably, each gateway device further includes a forwarding engine which forwards a portion of data traffic to each of the data networks. Preferably, the gateway device further includes a load balancing module which transfers a portion of the data traffic to the subsequent gateway device. Preferably the mechanism is performed using an external network management system operatively connected to the gateway device and the external network management system passes control from the gateway device to the subsequent gateway device. Preferably, the gateway device is internally synchronized with the subsequent gateway device to smoothly transfer services upon failure to the subsequent gateway device.

According to the present invention there is provided a fail-close device, ie. gateway or router, the device operatively connecting pairwise two data networks. The device includes a pair of network modules including a first network module and a second network module. Each network module includes a first interface and a second interface and a mechanism which upon failure of any of the network modules, connects the first interface and the second interface, thereby maintaining data transfer between the first interface and the second interface. Each network module further includes a third interface, wherein a pair of network modules is interconnected by connecting the second interface of the first network module to the third interface of the second network module. The pair of network modules is further interconnected by connecting the second interface of the second network module to the third interface of the first network module. The pair of network modules is connected pairwise to the two data networks using the first interface of the first network module and the first interface of the second network module. Preferably, each network module further includes a security module between at least two of the three interfaces which provides security to the data networks and/or data traffic. Preferably, the data traffic is stopped through network modules when both network modules have failed. Preferably, one or more network modules includes a load balancing module which transfers a portion of the data traffic to another network module, and the pair of network modules is internally synchronized, so that services are continued by the second network module upon failure of the first network module.

### BRIEF DESCRIPTION OF THE DRAWINGS

The invention is herein described, by way of example only, with reference to the accompanying drawings, wherein:

FIG. 1 (prior art) is a simplified system drawing of a fail-open interface.

FIG. 2 is a simplified system drawing according to an embodiment of the present invention of a pair of fail-open interfaces connected between two networks;

FIG. 3 is a simplified drawing of a gateway device, according to an embodiment of the present invention;

FIG. 4 is a drawing of a fail-close network device connecting two networks, according to an embodiment of the present invention; and

FIG. 5 is a drawing of a second embodiment for a fail-close network device connecting two networks, according to an embodiment of the present invention.

### DESCRIPTION OF THE PREFERRED EMBODIMENTS

The present invention is of a system for providing high availability in a network without requiring a special configuration for the network components. Specifically, the system includes use of one or more fail-open interfaces.

The principles and operation of a system and method of providing high availability in a network using fail-open interfaces, according to the present invention, may be better understood with reference to the drawings and the accompanying description.

It should be noted, that although the discussion herein relates to network components with a security function such as inspecting data traffic for security threats, the present invention may, by non-limiting example, alternatively be configured as well using network components with alternative or additional functions, such as data compression.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, the principal intention of the present invention is to providing high availability to networks in a fashion that is easy to configure based on a small number, e.g. one, of specialized network components, a “fail-open” interface.

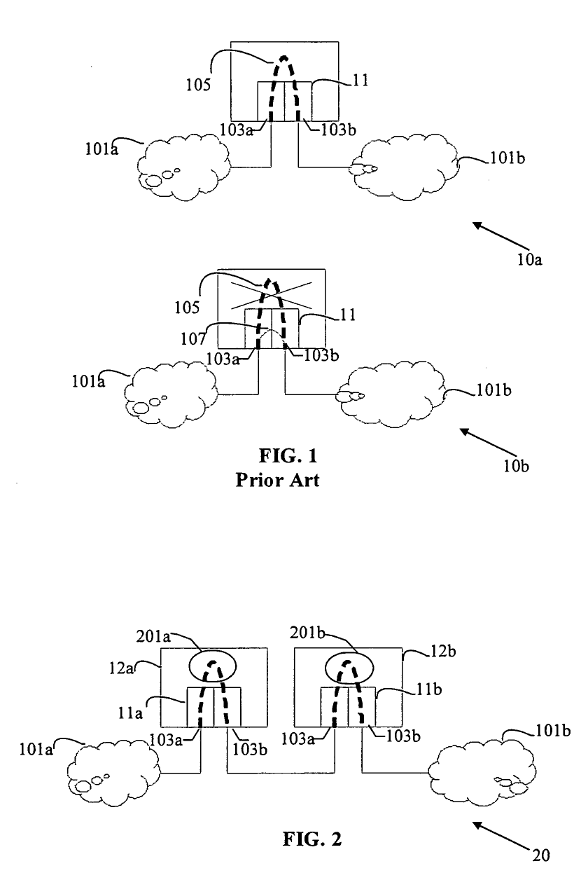

Referring now to the drawings, FIG. 1 (prior art) illustrates a network configuration 10a including a “fail-open” interface pair 11, connecting a data network 101a to a second data network 101b. In network configuration 10a, fail-open interface pair 11 is fully operational. Data traffic is passing through connector 103a to and from network 101a. Similarly, traffic is passing through connector 103b to and from network 101b. Typically, fail open interface pair 11 is a part of a component of a ring network, e.g. token ring so that the network operates even after a failure of the ring network component. Fail-open interface pair 11 is configured to “open” on failure either of interface pair 11 or on failure of the network device connected to interface 11. The open state is shown schematically in network configuration 10b, where the crossed lines over dotted line 105 signify the failure of the network device. Solid line 107 signifies that upon the failure of the network device, or upon failure of interface 11, data traffic is transferred directly between connectors 103a and 103b bypassing the failed network device. The connection in prior art fail-open interface is achieved typically with a switch or relay, either for optical or copper connections. In the case of Ethernet connections, the wires are typically crossed.

According to embodiments of the present invention, fail-open interface 11 is included in a network device which further includes for instance a firewall or other module for inspecting the data traffic or otherwise providing security. Network configuration 10 provides high availability of connectivity when the security or other functions of the gateway may be sacrificed in order to maintain the data traffic between networks.

A possible configuration 20 of the current invention is shown in FIG. 2. Configuration 20 includes two modules 12, connected in series with networks 101 for instance in a bridge configuration. Specifically, network 101a is connected to connector 103a of module 12a; connector 103b of module 12a is connected to connector 103a of module 12b; and connector 103b of module 12b is connected to network 101b. Modules 12 include a fail-open interface 11 as well as a security engine, e.g. inspection engine 201.

During normal operation, in some embodiments of configuration 20, data traffic between networks 101a and 101b is inspected twice by inspection engine 201a and inspection engine 201b. On failure of one of modules 12a or 12b (for example failure of 201a or 201b) the associated fail-open interfaces 11a or 11b will switch to fail-open operation mode, the data traffic is still inspected once by the other module. Only on failure of both modules is the data traffic not inspected. In alternative embodiments, a load-sharing module (not shown) is included in module 12, between fail-open interface 11 and security engine 201. When both modules 12a and 12b are operational, the load sharing module passes some of the traffic to the local inspection engine 201 and other traffic to the other module 12 for inspection, so that the load is balanced and the same data is not generally inspected more than once. A mechanism for load balancing in configuration 20 includes tagging packets that are inspected by 201a so that upon reaching 201b the tag is read and the tagged packet is not inspected again. With IPv4 traffic an additional Ethernet protocol number (or in IPv6 a different protocol number) may be used for the tagging of the inspected packet.

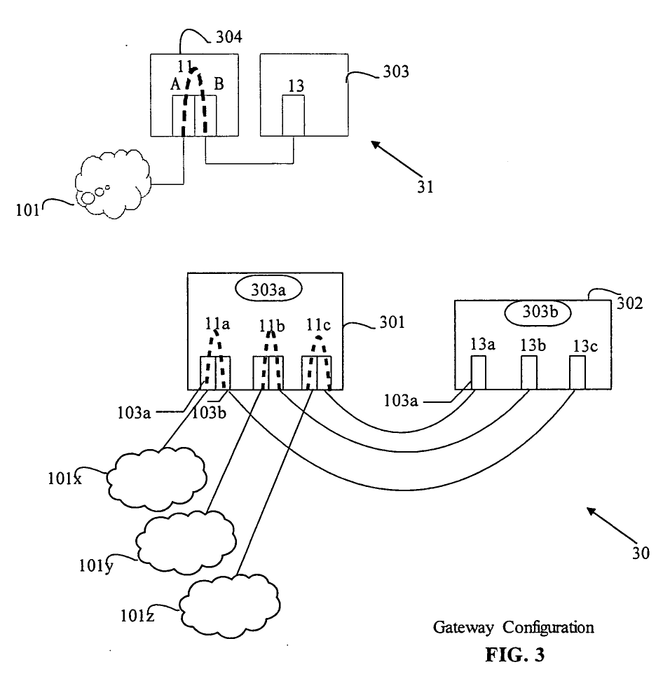

A gateway configuration 30, according to an embodiment of the present invention, is illustrated in FIG. 3. Configuration 31 is also shown as a basic building block of configuration 30. Configuration 31 includes a module 304 with a fail open interface 11. Fail-open interface 11 is connected to a module 303 via a standard interface 13. Configuration 31 is operable with modules 303 and 304 configured as a proxy or with both modules 303 and 304 configured as servers in which the content is duplicated on both modules 303 and 304 or the state of module 303 is synchronized with the state of 304, so that module 304 can take over the activity performed by 303 in any given moment. Gateway configuration 30 includes a gateway device 301. Gateway device 301 includes three fail-open interfaces 11 and further includes a forwarding engine 303a. Each fail open interface 11 is connected to a data network 101. Gateway configuration 30 shows three data networks, 101x, 101y, and 101z connected respectively to fail-open interfaces 11a-11c via network-interfaces 103a. Gateway configuration 30 further includes a terminal gateway 302 which includes conventional network interfaces 13 and a forwarding engine 303b. In configuration 30, interface 13a of terminal gateway 302 is connected to network-connector 103b of fail-open interface 11c of gateway device 301. Similarly, interface 13b is connected to connector 103b of fail-open interface 11b and interface 13c is connected to connector 103b of fail-open interface 11a. It should be noted that the use of three basic building blocks 31 is for illustration purposes only, embodiments of the present invention, may be configured with any number (greater than zero) of basic building blocks 31. In some embodiments of the present invention fail-open interface 11 is simpler than in configurations 10 and 20. In configuration 30, the interface port connected to connector 103a needs to fully function and communicate for instance with forwarding engine 303a while the connector 103b needs only to be able to pass and receive signals electronically or optically, i.e. in the physical layer only to and from terminal gateway 302.

During normal operation, i.e. none of the components have failed, forwarding engine 303a, forwards traffic between data networks 101x, 101y, and 101z respectively through three interfaces 103a while three connectors 103b and terminal gateway 302 are inactive. It is noteworthy that the behavior here differs from configuration 20, where forwarding was performed between connectors 103a and 103b. Typically, gateway 301 includes additional functional modules (not shown), for instance for data inspection or encryption. In an alternative embodiment, a load sharing module (not shown in 30) is incorporated into gateway device 301 for load sharing with terminal gateway 302. During load sharing, each interface pair 103 forwards some of the traffic to terminal gateway 302 for processing, i.e. data inspection or encryption.

A failure in gateway device 301, such as a power failure or a failure of forwarding engine 303a, results in all fail-open interfaces 11a-11c, opening and diverting data traffic to respective interfaces 13a-13c. Terminal module 302 then receives all the load and forwarding engine 303b operates to forward traffic appropriately to data networks 101x-101z. Failure detection is preferably local, i.e. part of the hardware/software configuration of gateway device 301.

In some configurations, e.g. in configurations 20 and 30, failure detection may be performed by a network management system. Upon monitoring, abnormal behavior of, for instance, fail-open interface 11b of configuration 20, the network management system sends a command, either automatically or with human intervention to disable misbehaving fail-open interface 11b, causing fail-open interface 11b to open. In configuration 30, upon failure of module 303a, all traffic is typically diverted to and from fail-open interfaces 11a, 11b, and 11c to corresponding interfaces 13a-c of terminal gateway 302, either automatically or with human intervention with or without a network management system.

In an alternative embodiment, terminal device 302 is replaced with another gateway device 301 with connectors 103b unused. If a higher availability is required than offered by configuration 30, two or more gateway devices 301 may be interconnected as a chain in series, connecting respectively connectors 103b to connectors 103a of the following gateway device 301. Each link of the chain is similarly connected as shown in configuration 30, with an optional termination of the chain by terminal gateway 302. Preferably, upon failure of one of the gateway devices 301, services provided by the failed device 301 are smoothly transferred to subsequent gateway device 301 (or terminal gateway device 302) because the gateway devices 301 and/or 302 are internally synchronized.

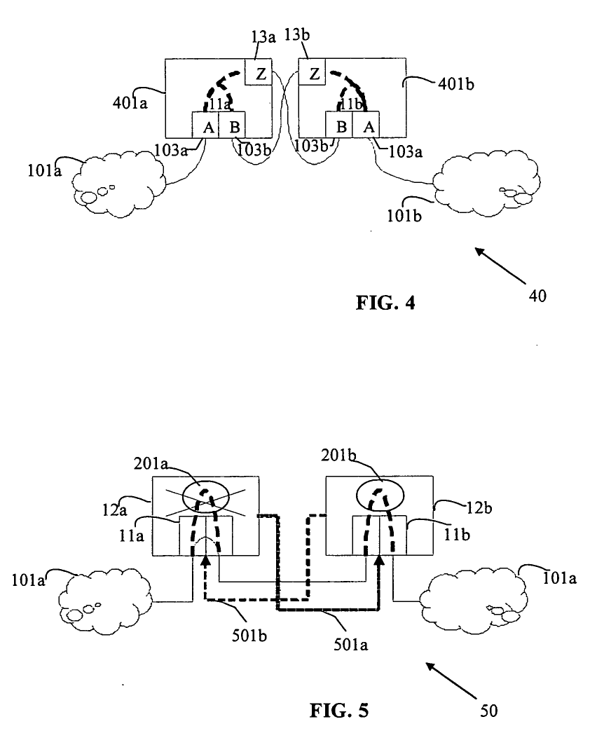

Reference is now made to FIG. 4, illustrating a fail-close configuration 40, according to an embodiment of the present invention. Fail-close configuration 40 includes two modules 401 interconnected, for example, in a bridge configuration. Module 401 includes a fail-open interface 11, as well as a standard interface 13. Modules 401 optionally include other functional modules (not shown), such as data inspection and/or encryption for security and optionally a load sharing module.

For each module 401, the following rules apply for normal operation, i.e. no components have failed:

data traffic coming from 103a is (for instance inspected and) passed to interface 13, and

data traffic coming from 13 or 103b is (for instance inspected and) passed to 103a.

In fail-close configuration 40, connector 103a of fail-open interface 11a of module 401a is connected to data network 101a and connector 103b is connected to standard interface 13b of module 401b and the reverse configuration for module 401b.

During normal operation, i.e. no components have failed, data network 101a transfers data traffic to connector 103a of module 401a and then after preferably inspecting the data, the data is passed to interface 13a. Interface 13a of module 401a passes traffic to connector 103b of module 401b. Traffic is then passed (and preferably inspected) from connector 103b to connector 103a of module 401b. Similarly, in the opposite direction, data network 101b transfers data traffic to connector 103a of interface 11b and then after preferably inspecting the data, passes the data to interface 13b. Interface 13b of module 401b passes traffic to connector 103b of module 401a. Traffic is then passed (and preferably inspected) from connector 103b to connector 103a each of module 401a. During normal operation the same data is inspected twice, unless load sharing is implemented between the modules If one of modules 401 fails in configuration 40, then the following rules apply:
traffic coming from connector 103a is passed directly to connector 103b (and not inspected)
traffic coming from connector 103b is passed directly to connector 103a (and not inspected)
traffic coming from 13a, 13b is dropped.

In the case that module 401a fails, traffic from network 101a reaches connector 103a of fail-open interface 11a and passes (without inspection) to connector 103b of fail-open interface 11a. From there, the data passes to interface 13b of module 401b properly functioning and inspecting data, and then the data passes to 103a of fail-open interface 11b to network 101b. In this case, the traffic is inspected just once. Similarly, when module 401b fails the data is inspected just once.

However, when both modules 401 fail, both fail-open interfaces are open. In this case, traffic from network 101a reaches connector 103a of fail open interface 11a. Since module 401a has failed, the data is passed (without inspection) to connector 103b of fail-open interface 11a. From there the data is passed to interface 13b and dropped. Therefore, when both modules 401 have failed no traffic can pass. Consequently, fail-close configuration 40 provides a high availability solution that stops traffic when both modules 401 have failed.

Reference is now made to FIG. 5, illustrating an alternative fail-close configuration 50, according to an embodiment of the present invention. Fail-close configuration is similar to fail-open configuration 20 of FIG. 2. Module 12 includes a fail-open interface 11 as well as a engine, e.g. inspection engine 201. Configuration 50 includes two modules 12, connected in series with networks 101 for instance in a bridge configuration. Specifically, network 101a is connected to connector 103a of module 12a; connector 103b of module 12a is connected to connector 103a of module 12b; and connector 103b of module 12b is connected to network 101b.

Typically, under normal operation, i.e. neither module 12 has failed, traffic between networks 101 is inspected twice by inspection engines 201a and 201b. Preferably, one or both modules 12 includes a load balancing module (not shown) to balance the inspection load between modules 12. Configuration 50 further includes additional connections, connection 501a from module 12a to fail open interface 11b of module 12b and connection 501b from module 12b to fail-open interface 11a of module 12a. Connections 501 provide an enabling signal to “keep open” or “keep traffic flowing”. During normal operation, when neither module 12 has failed, operation is analogous to the operation of configuration 20. However, when one of the modules 12 fails, such as indicated by the crossed lines on module 12a, then fail-open interface 11a opens causing data traffic to flow inspected only by engine 201b within module 12b. As long as the enabling signal from connection 501b is present, then fail-open interface 11a remains open and data traffic flows. However, if the enabling signal over connection 501b stops, indicating for instance a failure of module 12b, then fail-open interface 11a closes and data traffic is stopped until the enabling signal is restored indicating that module 12b has resumed proper function or until module 12a returns to normal operation and in which case there is no need for fail-open interface 11a to be in fail-open mode.

Preferably, when network module, e.g. 12a fails, the services performed by module 12a are smoothly passed to other module, e.g. 12b because modules 12 are internally synchronized during normal operation.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

While the invention has been described with respect to a limited number of embodiments, it will be appreciated that many variations, modifications and other applications of the invention may be made.

What is claimed is:

1. A method for providing high availability for data communications between two data networks, the method comprising the steps of:
(a) providing at least two network modules for operatively connecting the two data networks, each of said at least two network modules including two network interfaces;
(b) connecting together said at least two network modules using first network interfaces of said two network interfaces;
(c) operatively connecting the two data networks respectively to second network interfaces of said two network interfaces;
(d) providing at least one service of same type in each said at least two network modules; and
(e) upon failure of each said network module, operatively interconnecting said two network interfaces, thereby maintaining data traffic between said two network interfaces.

2. The method, according to claim 1, wherein said providing at least one service is selected from the group consisting of data inspection, data encryption, data filtering, data compression, and providing quality of service differentiation.

3. The method, according to claim 1, wherein said at least two network modules are internally synchronized, wherein said at least one service is continued by a second said network module upon failure of a first said network module.

4. The method, according to claim 1, wherein said failure is detected and said interconnecting is performed using an external network management system operatively connected to each said network module.

5. A network device operatively connecting pairwise at least two data networks, the device comprising a plurality of network modules, each said network module including:
(i) two interfaces;
(ii) a mechanism which upon failure of said network module, operatively interconnects said two interfaces, thereby maintaining data traffic between said two interfaces; and
(iii) a service module operatively connected between said two interfaces which provides a service to at least a portion of the at least two data networks;
wherein said network modules are connected in series using said two interfaces, thereby producing at least one chain of said network modules, and said at least one chain is further connected to the at least two data networks using said interfaces terminal to said at least one chain.

6. The device, according to claim 5, wherein said mechanism is further based on a signal received from another of said network modules, wherein said signal validates proper function of said another network module, whereby said data traffic does not pass when all the network modules fail.

7. The device, according to claim 5, wherein said mechanism includes an external network management system.

8. The device, according to claim 5, whereby said service is performed in at least one chain when at least one of said network modules of said at least one chain is functional.

9. The device, according to claim 5, wherein each said network module further includes a load balancing module which transfers a portion of said data traffic to at least one other said network module.

10. A cluster comprising a plurality of gateway devices, the cluster connected to a plurality of data networks, at least one said gateway device including a plurality of fail-open interface modules, each said fail-open interface module including:
(i) a first network interface;
{ii) a second network connection; and
(iii) a mechanism which upon failure of at least a portion of said at least one gateway device, operatively connects said first network interface to said second network connection, thereby maintaining data traffic between said first network interface and said second network connection;
wherein at least one said first network interface is operatively connectable to at least one of the data networks;
wherein said second network connection of each gateway device is connected pairwise to selectably either:
said first network interface of one of said fail-open modules of a subsequent gateway device of the chain, or
a regular network interface when said subsequent gateway device is the last said gateway device of the chain.

11. The cluster, according to claim 10, wherein each gateway device further includes a forwarding engine which forwards a portion of data traffic to each of the data networks.

12. The cluster, according to claim 10, wherein said at least one gateway device further includes a load balancing module which transfers a portion of said data traffic to said subsequent gateway device.

13. The cluster, according to claim 10, wherein said mechanism is performed using an external network management system operatively connected to said at least one gateway device.

14. The cluster, according to claim 13, wherein said external network management system passes control from said at least one gateway device to said subsequent gateway device.

15. The cluster, according to claim 10, wherein said at least one gateway device is internally synchronized with said subsequent gateway device.

16. A fail-close device operatively connecting pairwise at least two data networks, the device comprising at least one pair of network modules including a first network module and a second network module, each said network module including:
(i) a first interface and a second interface;
(ii) a mechanism which upon failure of any of said network modules, operatively connects said first interface and said second interface, thereby maintaining data transfer between said first interface and said second interface; and
(iii) a third interface,
wherein said at least one pair of network modules is interconnected by connecting said second interface of said first network module to said third interface of said second network module;
wherein said at least one pair of network modules is further interconnected by connecting said second interface of said second network module to said third interface of said first network module;
wherein said at least one pair of network modules is connected pairwise to the at least two data networks using said first interface of said first network module and said first interface of said second network module.

17. The device, according to claim 16, wherein each said network module further includes a security module operatively connected between at least two of said three interfaces which provides security to at least a portion of the at least two data networks.

18. The device, according to claim 16, whereby data traffic is stopped through said at least one pair of network modules when both said network modules of said at least one pair have failed.

19. The device, according to claim 16, wherein at least one of said network modules includes a load balancing module which transfers a portion of said data traffic to another said at least one network module.

20. The device, according to claim 16, wherein said at least one pair of network modules is internally synchronized, wherein said at least one service is continued by said second network module upon failure of said first network module
